(19) United States
(12) Patent Application Publication
(10) Pub. No.: US 2005/0187884 A1
(43) Pub. Date: Aug. 25, 2005

(54) Online seal and dispute resolution process

(76) Inventors: Stanley Lawrence Reisch, Westlake Village, CA (US); Charles Allen Goldman, Sherman Oaks, CA (US); Gary Leonard Reisch, Sherman Oaks, CA (US)

Correspondence Address: Stanley Reisch, 181 Little John Court, Westlake Village, CA, 91361, US

(21) Appl. No.: 11/031,612

(22) Filed: Jan. 7, 2005

Related U.S. Application Data
(60) Provisional application No. 60/536,587, filed on Jan. 14, 2004.

(51) Int. Cl. G06F 17/60

(52) U.S. Cl. 705/80

(57) ABSTRACT

The process begins when the merchant applies for a seal (Trustmark). The merchant fills out an application and if approved is granted a seal. The merchant is provided with coding to display the seal on their website. The consumer (or other entity) can file a complaint by either using the seal on the merchants website or through the complaint filing process on our website. Once the complaint is filed, there are two rounds of negotiation, using a combination of e-mail and our website resources, between the consumer and merchant to try and resolve the problem or dispute. If there is no resolution, a mediator is brought in to help the parties come to a settlement. There are two rounds of mediation and if the problem or dispute is still unresolved, the mediator will review the case and make an arbitrated decision in favor of either the consumer or merchant.

### RELATED APPLICATIONS

The present application is a continuation application of U.S. provisional patent application, Ser. No. 60/536,587, filed Oct. 14, 2004, for ONLINE SEAL (TRUSTMARK) AND DISPUTE RESOLUTION PROCESS, by Stanley Lawrence Reisch, Charles Allen Goldman, Gary Leonard Reisch, included by reference herein and for which benefit of the priority date is hereby claimed.

### FIELD OF THE INVENTION

The present invention relates to a dispute resolution process and, more particularly, to using automated, computer based, processes to resolve disputes between businesses and consumers, businesses and businesses or governments and either businesses or consumers.

### BACKGROUND OF THE INVENTION

There is rapidly growing number of problems in resolving online disputes caused by the exponential increase in e-commerce transactions. With the number of complaints more than doubling each year. Every month the Federal Trade Commission and Consumer Protection Organizations receive thousands of complaints from disgruntled consumers who are having problems or disputes with merchants selling goods and services online.

Conventional litigation is expensive and time consuming and does not offer a satisfactory resolution of online disputes. Alternative Dispute Resolution which include negotiation, mediation and arbitration which must be carried on in person does not lend itself to the resolution of online disputes, especially where crossboarder disputes are involved. The shortcomings of the other online dispute resolution process solutions are that they are not easy to use, are not automated and do not provide the parties an arbitrated resolution to the dispute, if negotiation and mediation fail.

It is therefore an object of the invention to provide online merchants and consumers a fast, fair, inexpensive and effective way to resolve their disputes.

It is another object of the invention to provide an online dispute resolution process that will make it easier for consumers to resolve disputes caused by purchases made over the Internet.

It is another object of the invention to provide merchants with the opportunity to enhance their in house customer service programs by providing their customers with a seal and online dispute resolution process in order to resolve disputes arising from their business transactions.

It is another object of the invention to provide consumers with the opportunity to resolve disputes that are not resolved through a merchants in house customer service programs, by filing a claim so that the dispute can be resolved in a fast, fair and impartial manner by an independent third party.

It is another object of the invention to provide both merchants and consumers a way to resolve cross boarder (international) disputes created from business transactions using an automated and simple to use online dispute resolution process.

It is another object of the invention to provide a simple to use and automated process so as to provide the parties involved, with a superior online dispute resolution process, over other alternative dispute resolution systems or processes.

It is another object of the invention to provide a process that can be used by anyone with a computer and Internet connection, 24 hours a day, seven days a week, 365 days a year, to resolve disputes of any kind.

It is another object of the invention to provide merchants with an opportunity to display a seal on their website indicating that should a dispute arise from a transaction, they will take part in an online dispute resolution process in order to resolve the dispute.

It is another object of the invention to provide consumers a way to find out information about the merchant or file a claim arising from a transaction in order to take part in an online dispute resolution process to resolve the dispute.

It is another object of the invention to provide a website where a consumer can file a claim against a merchant arising from a dispute over a transaction, where the merchant will be contacted and made aware of the claim and offered the opportunity to participate in a dispute resolution process in order to resolve the dispute with the consumer.

It is another object of the invention to provide an online dispute resolution process that provides a way for the consumer and merchant to take part, initially, in a two stage negotiation using a combination of e-mail exchanges and website information leading to a negotiated settlement of the dispute.

It is another object of the invention to provide a continued online dispute resolution process, should the negotiation fail to resolve the dispute, that includes a two stage mediation using a combination of e-mail exchanges and website information leading to a mediated settlement of the dispute.

It is another object of the invention to provide resolution through an arbitrated decision.

It is another object of the invention to provide the same online dispute resolution process for resolving disputes between businesses and businesses or governments and either businesses or consumers.

### SUMMARY OF THE INVENTION

In accordance with the present invention, there is provided a online seal and dispute resolution process using automated, computer based, processes to resolve disputes between businesses and consumers, businesses and businesses or governments and either businesses or consumers.

In order to create a seal a merchant would visit the website and select the merchant seal creation form, fill it out and then submit it. The merchant information is reviewed by a staff member for accuracy. If the information is valid then a seal is activated for that merchant otherwise the seal is denied. If the merchant is accepted an e-mail is sent to them with the code to be displayed on their website which needs to be placed on their site by their webmaster and the seal is then activated and valid.

When a consumer files a complaint via the website, an e-mail is sent to and address that belongs to a merchant. If there is no response from the merchant the complaint ends with an e-mail to the consumer. If the merchant chooses to respond to the complaint he is instructed to create a seal and the consumer is notified to go file a case. If the merchant does not request a seal the complaint is closed. If the consumer does not file a case the complaint is closed.

A case begins when a consumer clicks on a File a complaint button on a merchant's seal page. Consumer fills out the online form and then emails are set to both parties. If the merchant logs into their account and replies emails are sent to both parties. Otherwise an e-mail reminder is sent to the merchant to remind them after 24 hours. If the first mail is not responded to a second e-mail is sent as a reminder. If no response after 48 hours the case is closed and defaults to the consumer. If the merchant responded and offered to settle a notation is made in the system informing the consumer and the case continues. If the consumer logs into their account and replies emails are sent to both parties. Otherwise an e-mail reminder is sent to the consumer to remind them after 24 hours. If the first mail is not responded to a second e-mail is sent as a reminder. If no response after 48 hours the case is closed and defaults to the merchant. If the consumer responded and offered to settle a notation is made in the system informing both parties. The case is settled otherwise the case continues. If the merchant logs into their account and replies emails are sent to both parties. Otherwise an e-mail reminder is sent to the merchant to remind them after 24 hours. If the first mail is not responded to a second e-mail is sent as a reminder. If no response after 48 hours the case is closed and defaults to the consumer. If the merchant responded and offered to settle a notation is made in the system informing the consumer and the case continues. If the consumer logs into their account and replies emails are sent to both parties. Otherwise an e-mail reminder is sent to the consumer to remind them after 24 hours. If the first mail is not responded to a second e-mail is sent as a reminder. If no response after 48 hours the case is closed and defaults to the merchant. If the consumer responded and offered to settle a notation is made in the system informing both parties. The case is settled otherwise the case continues. If the merchant logs into their account and replies emails are sent to both parties. Otherwise an e-mail reminder is sent to the merchant to remind them after 24 hours. If the first mail is not responded to a second e-mail is sent as a reminder. If no response after 48 hours the case is closed and defaults to the consumer. If the merchant responded and offered to settle a notation is made in the system informing the consumer and the case continues.

If case is not resolved by negotiation, it is manually assigned to a mediator by the case administrator. An e-mail is sent to the mediator automatically to alert them they have a new case. The mediator logs into their account and recommends a solution and an e-mail is sent to all parties. If the consumer logs into their account and replies emails are sent to both parties. Otherwise an e-mail reminder is sent to the consumer to remind them after 24 hours. If the first mail is not responded to a second e-mail is sent as a reminder. If no response after 48 hours the case is closed and defaults to the merchant. If the consumer responded and offered to settle a notation is made in the system informing both parties. The case is settled otherwise the case continues. If the merchant logs into their account and replies emails are sent to both parties. Otherwise an e-mail reminder is sent to the merchant to remind them after 24 hours. If the first mail is not responded to a second e-mail is sent as a reminder. If no response after 48 hours the case is closed and defaults to the consumer. If the merchant responded and offered to settle a notation is made in the system informing the consumer and the case continues.

The mediator logs into their account and recommends a solution and an e-mail is sent to all parties. If the consumer logs into their account and replies emails are sent to both parties. Otherwise an e-mail reminder is sent to the consumer to remind them after 24 hours. If the first mail is not responded to a second e-mail is sent as a reminder. If no response after 48 hours the case is closed and defaults to the merchant. If the consumer responded and offered to settle a notation is made in the system informing both parties. The case is settled otherwise the case continues. If the merchant logs into their account and replies emails are sent to both parties. Otherwise an e-mail reminder is sent to the merchant to remind them after 24 hours. If the first mail is not responded to a second e-mail is sent as a reminder. If no response after 48 hours the case is closed and defaults to the consumer. If the merchant responded and offered to settle a notation is made in the system informing the consumer and the case continues.

The mediator logs into their account and makes a final arbitration and an e-mail is sent to all parties. The case is resolved.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a flow chart view of an inventive seal process;

FIG. 2 is a flow chart view of a consumer complaint filing process; and

FIG. 3 is a flow chart view of an automated online dispute resolution process which includes 3a through 3d, when taken together represent the entire process.

For purposes of clarity and brevity, like elements and components will bear the same designations and numbering throughout the FIGURES.

### DESCRIPTION OF THE PREFERRED EMBODIMENT

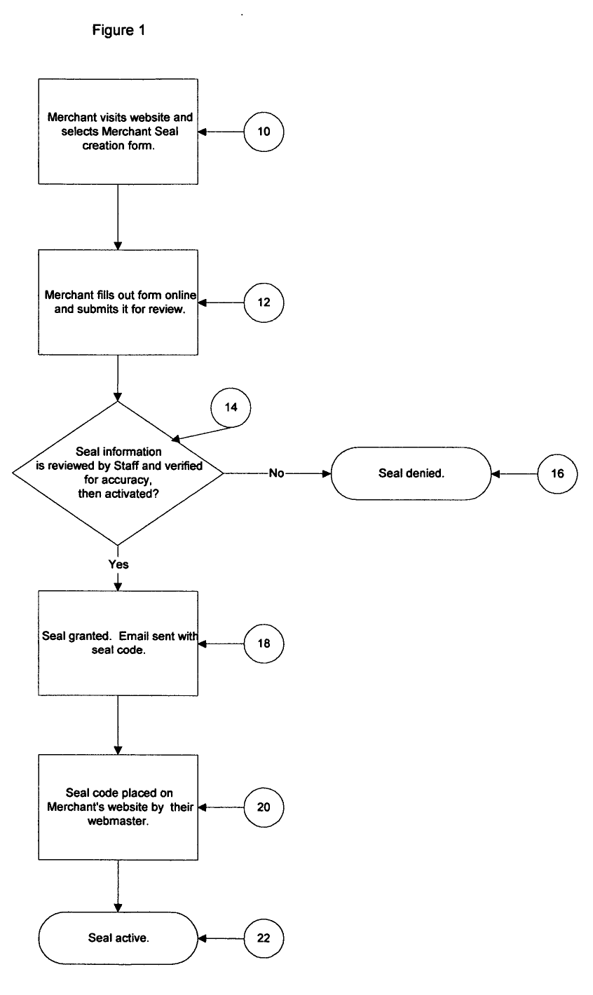

FIG. 1 is a flow chart which illustrates the steps of the seal or trustmark process of the invention. The process begins with the creation of a merchant seal (Step 10) which is a graphic representation of the seal. A form is provided for the merchant to make an application for the merchant seal (Step 12). Once the merchant submits an application online, the system reviews the information provided by the merchant (Step 14) to determine if the merchant is qualified to receive a merchant seal. If not the merchant is denied a seal (Step 16). If the information is successfully verified the seal is granted to the merchant (Step 18) and an e-mail is sent to the merchant containing the seal code. The seal code is placed on the merchants website by the merchant's webmaster (Step 20) and the graphic representation of the seal is activated on the merchants website (Step 22).

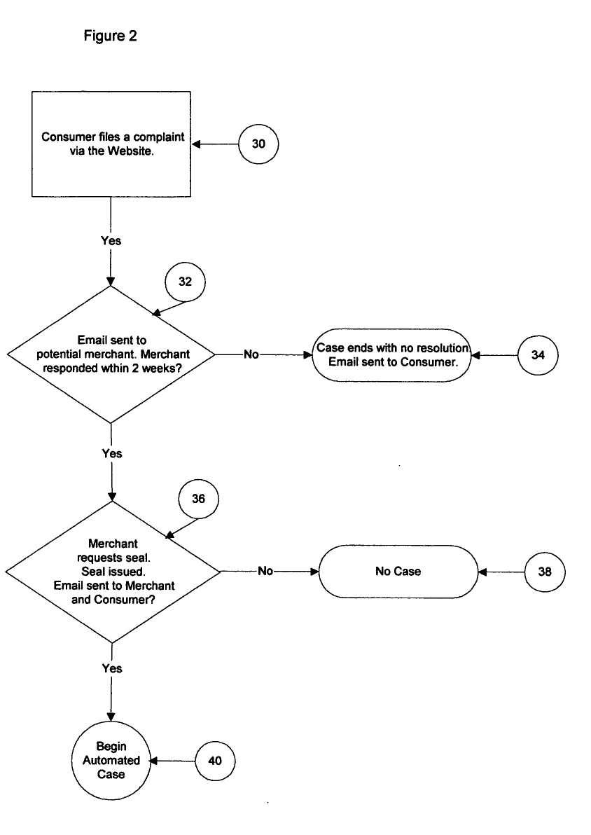

FIG. 2 is a flow chart which illustrates the steps of the consumer complaint filing process of the invention. The process begins when the consumer files a complaint on the system website (Step 30). An e-mail is sent to the potential merchant seal holder (Step 32) requesting a response to the complaint within two weeks. If the merchant does not request a seal the case is ended with no resolution and an e-mail is sent to the consumer (Step 34). If the merchant requests a seal, the seal creation 11 information is e-mailed to the merchant and the seal is issued (Step 36) and an e-mail is sent to the consumer instructing them to go to the merchants website and refile the complaint using the merchant seal. If the merchant still does not responded to the request the case is ended with no resolution and an e-mail is sent to the consumer (Step 38). If the merchant then responds to the complaint, the automated case process begins (Step 40).

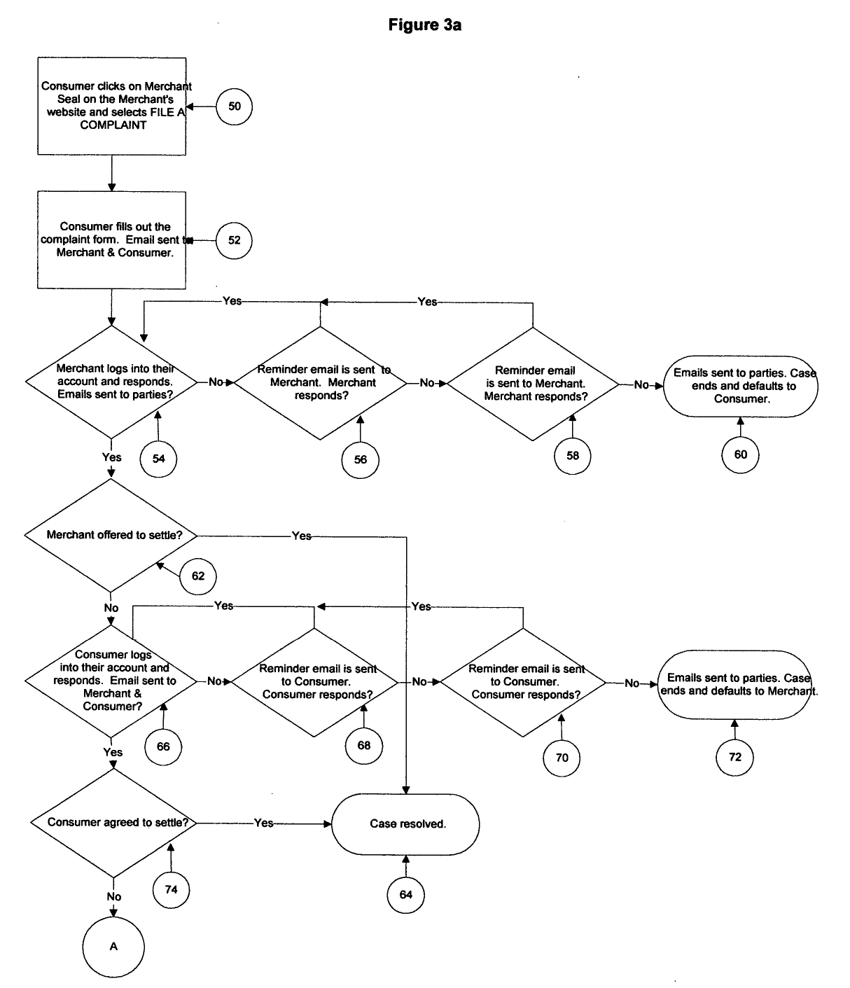

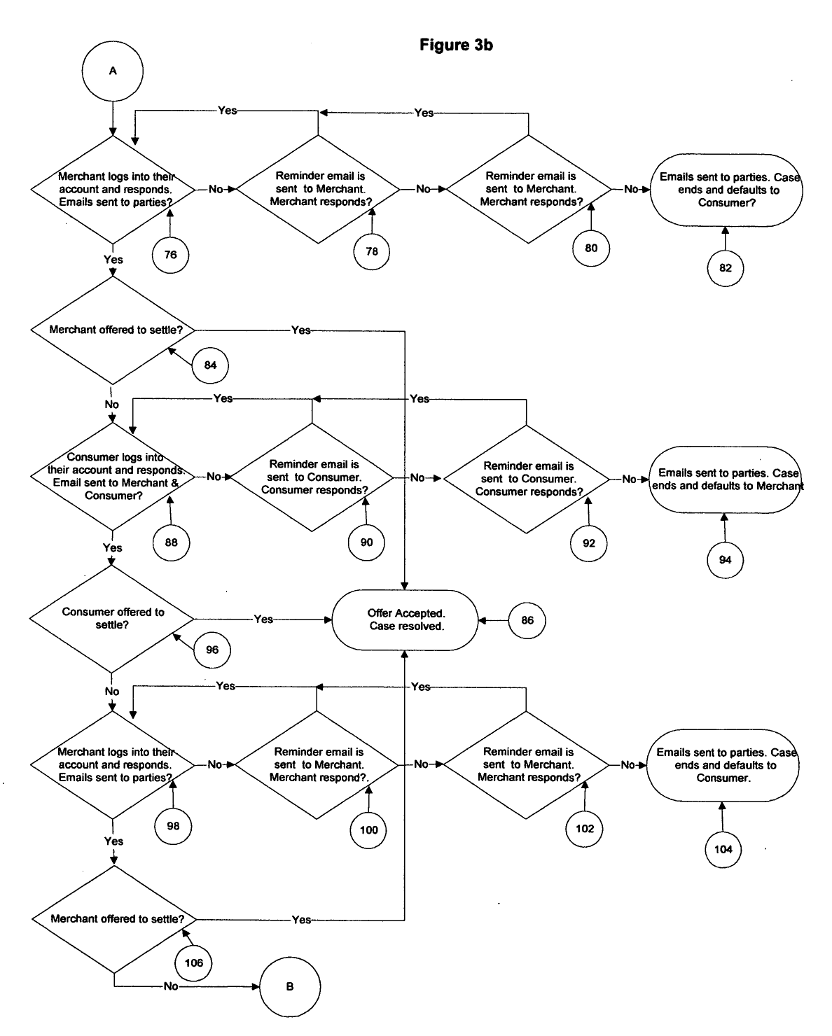

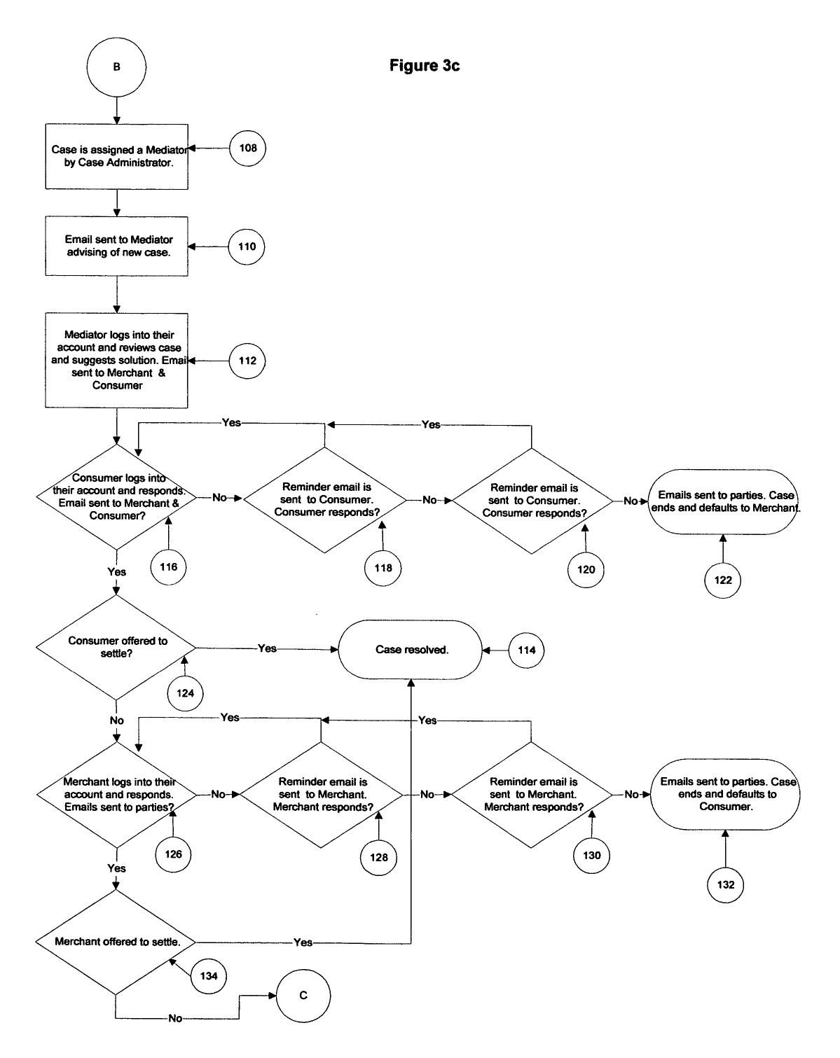

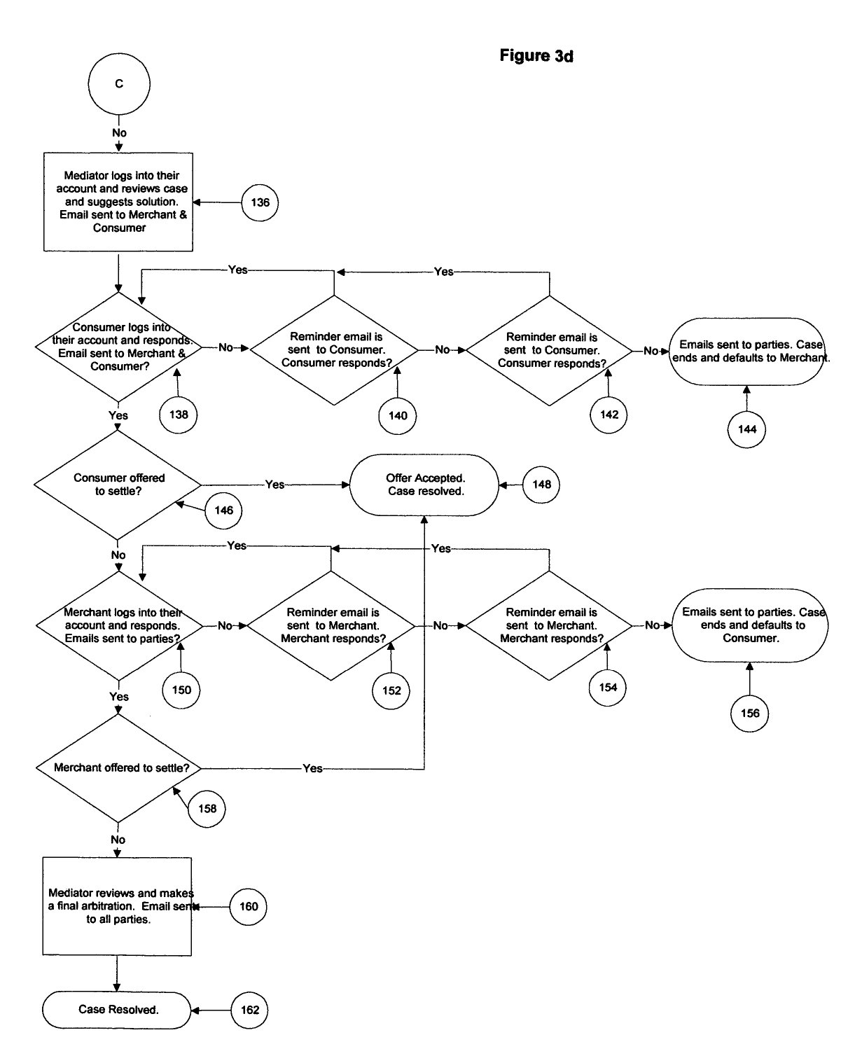

FIG. 3a through 3d, taken together, is a flow chart which illustrates the automated online dispute resolution process of the invention. It begins when the consumer goes to the merchants website and selects File A Complaint (Step 50). The consumer fills out the complaint form and and e-mails acknowledging this event are sent to both parties (Step 52). The merchant logs into their account to respond to the complaint and e-mails acknowledging this event are sent to both parties (Step 54). If the merchant does not respond, a reminder notice is sent to the merchant to respond to the complaint (Step 56). If the merchant still does not respond, a 2nd reminder notice is sent to the merchant to respond to the complaint (Step 58). If there is no response from the merchant, e-mails are sent to both parties indicating that the merchant did not respond to the complaint, the case has ended and defaults in favor of the consumer (Step 60). If the merchant makes an offer to settle (Step 62) and the consumer agrees to the offer, the case is resolved (Step 64) and e-mails acknowledging this event are sent to both parties. If there is no offer to settle, the consumer logs into their account to respond to the complaint and e-mails acknowledging this event are sent to both parties (Step 66). If the consumer does not respond, a reminder notice is sent to the consumer to respond to the complaint (Step 68). If the consumer still does not respond, a 2nd reminder notice is sent to the consumer to respond to the complaint (Step 70). If there is no response from the consumer, e-mails are sent to both parties indicating that the consumer did not respond to the complaint, the case has ended and defaults in favor of the merchant (Step 72). If the consumer makes an offer to settle (Step 74) and the merchant agrees to the offer, the case is resolved (Step 64) and e-mails acknowledging this event are sent to both parties. If there is no settlement the process continues with the merchant loging into their account to respond to the complaint and e-mails acknowledging this event are sent to both parties (Step 76). If the merchant does not respond, a reminder notice is sent to the merchant to respond to the complaint (Step 78). If the merchant still does not respond, a 2nd reminder notice is sent to the merchant to respond to the complaint (Step 80). If there is no response from the merchant, e-mails are sent to both parties indicating that the merchant did not respond to the complaint, the case has ended and defaults in favor of the consumer (Step 82). If the merchant makes an offer to settle (Step 84) and the consumer agrees to the offer, the case is resolved (Step 86) and e-mails acknowledging this event are sent to both parties. If there is no offer to settle, the consumer logs into their account to respond to the complaint and e-mails acknowledging this event are sent to both parties (Step 88). If the consumer does not respond, a reminder notice is sent to the consumer to respond to the complaint (Step 90). If the consumer still does not respond, a 2nd reminder notice is sent to the consumer to respond to the complaint (Step 92). If there is no response from the consumer, e-mails are sent to both parties indicating that the consumer did not respond to the complaint, the case has ended and defaults in favor of the merchant (Step 94). If the consumer makes an offer to settle (Step 96) and the merchant agrees to the offer, the case is resolved (Step 86) and e-mails acknowledging this event are sent to both parties. If there is still no settlement, the merchant logs into their account to respond to the complaint and e-mails acknowledging this event are sent to both parties (Step 98). If the merchant does not respond, a reminder notice is sent to the merchant to respond to the complaint (Step 100). If the merchant still does not respond, a 2nd reminder notice is sent to the merchant to respond to the complaint (Step 102). If there is no response from the merchant, e-mails are sent to both parties indicating that the merchant did not respond to the complaint, the case has ended and defaults in favor of the consumer (Step 104). If the merchant makes an offer to settle (Step 106) and the consumer agrees to the offer, the case is resolved (Step 86) and e-mails acknowledging this event are sent to both parties. If there is still no settlement the process continues with a mediator being manually assigned to the case (Step 108). An e-mail is sent notifying the mediator of assignment to the case (Step 110). The mediator logs in to their account and makes a recommendation for a resolution of the case and an e-mail is sent to both parties acknowledging this event (Step 112). The consumer again logs into their account to respond to the recommendation and e-mails acknowledging this event are sent to both parties (Step 116). If the consumer does not respond, a reminder notice is sent to the consumer to respond to the complaint (Step 118). If the consumer still does not respond, a 2nd reminder notice is sent to the consumer to respond to the complaint (Step 120). If there is no response from the consumer, e-mails are sent to both parties indicating that the consumer did not respond to the complaint, the case has ended and defaults in favor of the merchant (Step 122). If the consumer makes an offer to settle (Step 124) and the merchant agrees to the offer, the case is resolved (Step 114) and e-mails acknowledging this event are sent to both parties. If there is still no settlement, the merchant logs into their account to respond to the complaint and e-mails acknowledging this event are sent to both parties (Step 126). If the merchant does not respond, a reminder notice is sent to the merchant to respond to the complaint (Step 128). If the merchant still does not respond, a 2nd reminder notice is sent to the merchant to respond to the complaint (Step 130). If there is no response from the merchant, e-mails are sent to both parties indicating that the merchant did not respond to the complaint, the case has ended and defaults in favor of the consumer (Step 132). If the merchant makes an offer to settle (Step 134) and the consumer agrees to the offer, the case is resolved (Step 114) and e-mails acknowledging this event are sent to both parties. If again there again is no resolution, the mediator logs in to their account, reviews the case information and makes a recommendation for a resolution of the case and an e-mail is sent to both parties acknowledging this event (Step 136). The consumer again logs into their account to respond to the recommendation and e-mails acknowledging this event are sent to both parties (Step 138). If the consumer does not respond, a reminder notice is sent to the consumer to respond to the complaint (Step 140). If the consumer still does not respond, a 2nd reminder notice is sent to the consumer to respond to the complaint (Step 142). If there is no response from the consumer, e-mails are sent to both parties indicating that the consumer did not respond to the complaint, the case has ended and defaults in favor of the merchant (Step 144). If the consumer makes an offer to settle (Step 124) and the merchant agrees to the offer, the case is resolved (Step 148) and e-mails acknowledging this event are sent to both parties. If there is still no settlement, the merchant logs into their account to respond to the complaint and e-mails acknowledging this event are sent to both parties (Step 150). If the merchant does not respond, a reminder notice is sent to the merchant to respond to the complaint (Step 152). If the merchant still does not respond, a 2nd reminder notice is sent to the merchant to respond to the complaint (Step 154). If there is no response from the merchant, e-mails are sent to both parties indicating that the merchant did not respond to the complaint, the case has ended and defaults in favor of the consumer (Step 156). If the merchant makes an offer to settle (Step 158) and the consumer agrees to the offer, the case is resolved (Step 148) and e-mails acknowledging this event are sent to both parties. If there is no resolution to the case at this time, the mediator makes a final review of the case information and makes an arbitrated decision for a resolution of the case and an e-mail is sent to both parties acknowledging this event (Step 160). An e-mail is sent which notifies the parties that the mediator has issued a binding settlement to resolve the case and that the case is settled in favor of the consumer with a Certificate of Award e-mailed to the consumer (Step 162).

In the seal or trustmark process of the invention, the merchant first goes to the website and selects the Merchant Seal Creation 1 Form (Step 10).

Then the merchant fills out the online Merchant Application Form 2 and submits it for review (Step 12).

The submitted Information Review 3 is taken by a staff member and verified for accuracy then the seal is activated (Step 14).

If the information is substandard the the seal is denied (Step 16).

If the information is good then the seal is granted and an e-mail is sent to the merchant with the seal code (Step 18).

The merchant's webmaster applies the code to the merchant's website (Step 20).

The seal is then activated on the merchant's website (Step 22).

In the consumer complaint filing process of the invention, the consumer files a complaint via the website (Step 30).

An e-mail is sent to the potential merchant seal holder, at the address that belongs to a merchant (Step 32).

If there is no response from the merchant the case ends with no resolution and an e-mail is sent to the consumer (Step 34).

If the merchant chooses to respond to the complaint they are instructed to create a seal and the consumer is notified to go file a complaint (Step 36).

If the merchant does not request a seal then the none is issued and the complaint is closed (Step 38).

When the merchant is issued a seal, it is activated and automated case processing 14 can be initiated (Step 40).

The automated online dispute resolution process of the invention, begins when a consumer clicks a File A Complaint button on the merchant's website(Step 50).

The consumer fills out the online Case Creation Form 15 and then e-mails are set to both parties (Step 52).

If the merchant logs into their account to respond to the complaint, e-mails are sent to both parties (Step 54).

Otherwise an e-mail is sent to the merchant to remind them to reply within 24 hours (Step 56).

If the first e-mail is not responded to, a 2nd e-mail is sent to the merchant to remind them to reply within 24 hours (Step 58).

If there is no response from the merchant after 48 hours, the case is closed and defaults to the consumer (Step 60).

If the merchant responds with an offer to settle, a notation is made in the system informing the consumer of the offer (Step 62).

If the consumer agrees to the offer the case is resolved (Step 64).

If not, the consumer logs into their account to respond and e-mails are sent to both parties (Step 66).

Otherwise a reminder e-mail is sent to the consumer to remind them to reply within 24 hours (Step 68).

If the first e-mail is not responded to, a 2nd e-mail is sent to the consumer to remind them to reply within 24 hours (Step 70).

If there is no response from the consumer after 48 hours, the case is closed and defaults to the merchant (Step 72).

If the consumer responds and agrees to settle, a notation is made in the system informing both parties (Step 74).

The case is settled (Step 64), otherwise the case continues.

If the merchant logs into their account to respond, e-mails are sent to both parties (Step 76).

Otherwise an e-mail is sent to the merchant to remind them to reply within 24 hours (Step 78).

If the first e-mail is not responded to, a 2nd e-mail is sent to the merchant to remind them to reply within 24 hours(Step 80).

If there is no response from the merchant after 48 hours, the case is closed and defaults to the consumer (Step 82).

If the merchant responds with an offer to settle, a notation is made in the system informing the consumer of the offer (Step 84).

If the consumer agrees to the offer the case is resolved (Step 86).

If not, the consumer logs into their account to respond and e-mails are sent to both parties (Step 88).

Otherwise an e-mail is sent to the consumer to remind them to reply within 24 hours (Step 90).

If the first e-mail is not responded to, a 2nd e-mail is sent to the consumer to remind them to reply within 24 hours (Step 92).

If there is no response the consumer after 48 hours, the case is closed and defaults to the merchant (Step 94).

If the consumer responds and agrees to settle, a notation is made in the system informing both parties (Step 96).

The case is settled (Step 86), otherwise the case continues.

If the merchant logs into their account to respond, e-mails are sent to both parties (Step 98).

Otherwise an e-mail is sent to the merchant to remind them to reply within 24 hours (Step 100).

If the first e-mail is not responded to, a 2nd Notice e-mail is sent to the merchant to remind them to reply within 24 hours (Step 102).

If there is no response from the merchant after 48 hours the case is closed and defaults to the consumer (Step 104).

If the merchant responds with an offer to settle, a notation is made in the system informing the consumer of the offer (Step 106).

The case is settled (Step 86), otherwise the case continues.

If the case is not resolved, a mediator is manually assigned to the case by the case administrator (Step 108).

An e-mail is sent to the mediator, automatically, to alert them they have a new case (Step 110).

The mediator logs into their account and recommends a solution and an e-mail is sent to all parties (Step 112).

If the consumer logs into their account to respond, e-mails are sent to both parties (Step 116).

Otherwise an e-mail is sent to the consumer to remind them to reply within 24 hours (Step 118).

If the first e-mail is not responded to, a 2nd e-mail is sent to the consumer to remind them to reply within 24 hours (Step 120).

If there is no response from the consumer after 48 hours, the case is closed and defaults to the merchant (Step 122).

If the consumer responds and agrees to settle, a notation is made in the system informing both parties (Step 124).

The case is settled (Step 114), otherwise the case continues.

If the merchant logs into their account to respond, e-mails are sent to both parties (Step 126).

Otherwise an e-mail is sent to the merchant to remind them to reply within 24 hours (Step 128).

If the first e-mail is not responded to, a 2nd e-mail is sent to the merchant to remind them to reply within 24 hours (Step 130).

If there is no response from the merchant after 48 hours, the case is closed and defaults to the consumer (Step 132).

If the merchant responds with an offer to settle, a notation is made in the system informing the consumer of the offer (Step 134).

The case is settled (Step 114), otherwise the case continues.

If the case is not resolved, the mediator logs into their account and recommends a solution and an e-mail is sent to all parties (Step 136).

If the consumer logs into their account to respond, e-mails are sent to both parties (Step 138).

Otherwise an e-mail is sent to the consumer to remind them to reply within 24 hours (Step 140).

If the first e-mail is not responded to, a 2nd e-mail is sent to the consumer to remind them to reply within 24 hours (Step 142).

If there is no response from the consumer, after 48 hours, the case is closed and defaults to the merchant (Step 144).

If the consumer responds with an offer to settle, a notation is made in the system informing both parties (Step 146).

If the merchant agrees to the offer the case is settled (Step 148), otherwise the case continues.

If the merchant logs into their account to respond, e-mails are sent to both parties (Step 150).

Otherwise an e-mail is sent to the merchant to remind them to reply within 24 hours (Step 152).

If the first e-mail is not responded to, a 2nd e-mail is sent to the merchant to remind them to reply within 24 hours (Step 154).

If there is no response from the merchant after 48 hours the case is closed and defaults to the consumer (Step 156).

If the merchant responds with an offer to settle, a notation is made in the system informing both parties (Step 158).

If the consumer agrees to the offer the case is settled (Step 148), otherwise the case continues.

If the case is not resolved there is a final mediator review 69 of the case and the mediator logs into their account and makes a final arbitration and an e-mail is sent to all parties (Step 160).

If the case is resolved in favor of the consumer, a Final Case Resolution 70 notification is e-mailed to the consumer (Step 162).

It is the purpose of the present invention to provide an online seal and online dispute resolution (ODR) process using automated, computer based, processes to resolve disputes between consumers, merchants, businesses or governmental entities. These processes provide an integrated negotiation, mediation and arbitration dispute resolution solution, which is conducted online. The processes include the merchant applying for and receiving a distinctive, recognizable, seal to be displayed on the merchants website and identifying the ODR services to be provided to the consumer. The process further allows a consumer to file a complaint against a merchant who does not have a seal. The process then provides an online framework for the parties to exchange information and proposed solutions for resolving their dispute and if the parties are not able to resolve their dispute, a mediators/arbitrator is appointed to assist in resolving the dispute. The process further provides, that if, the parties are still unable to settle the dispute, the mediator/arbitrator will render a binding resolution to the dispute.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

Having thus described the invention, what is desired to be protected by Letters Patent is presented in the subsequently appended claims.

1. A method for resolving disputes between a merchant and a second party, the steps comprising:
a) filing a complaint against a merchant online by a second party;
b) responding to said complaint by said merchant online;
c) responding to said merchant response by said second party online;
d) assigning a case related to said complaint to a mediator online; and
e) performing final arbitration by said mediator online.

2. The method for resolving disputes in accordance with claim 1, wherein said second party comprises a consumer.

3. The method for resolving disputes in accordance with claim 1, wherein said second party comprises a government agency.

4. The method for resolving disputes in accordance with claim 1, the steps further comprising:
f) creating a seal online by the merchant for display on a website of said merchant.

5. The method for resolving disputes in accordance with claim 4, wherein said filing a complaint step (a) comprises clicking on said seal on said website of said merchant.

6. The method for resolving disputes in accordance with claim 1, wherein said responding to said complaint step (b) comprises receiving at least one automated reminder if said merchant fails to respond to said complaint within a first predetermined time interval after the receipt thereof.

7. The method for resolving disputes in accordance with claim 6, wherein, if said merchant fails to respond online within a second predetermined time interval of said at least one automated reminder said case defaults to said second party.

8. The method for resolving disputes in accordance with claim 1, wherein said responding to said complaint step (c) comprises receiving at least one automated reminder if said second party fails to respond to said complaint within a first predetermined time interval after the receipt thereof.

9. The method for resolving disputes in accordance with claim 8, wherein, if said second party fails to respond online within a second predetermined time interval of said at least one automated reminder said case defaults to said merchant.

10. The method for resolving disputes in accordance with claim 1, the steps further comprising:
g) resolving said case at any time wherein either party thereto tenders an acceptable settlement offer.

11. The method for resolving disputes in accordance with claim 1, wherein said responding steps (b) and (c) are repeated until one of the group of events occurs: one party fails to respond within a period set therefore, and a settlement offer is accepted.

12. A method for resolving disputes between a merchant and a second party, the steps comprising:
a) filing a complaint against a merchant online by a second party;
b) responding to said complaint by said merchant online;
c) responding to said merchant response by said second party online.

13. The method for resolving disputes in accordance with claim 12, the steps further comprising:
f) creating a seal online by the merchant for display on a website of said merchant.

14. The method for resolving disputes in accordance with claim 12, wherein said responding to said complaint step (b) comprises receiving at least one automated reminder if said merchant fails to respond to said complaint within a first predetermined time interval after the receipt thereof.

15. The method for resolving disputes in accordance with claim 14, wherein, if said merchant fails to respond online within a second predetermined time interval of said at least one automated reminder said case defaults to said second party.

16. The method for resolving disputes in accordance with claim 12, wherein said responding to said complaint step (c) comprises receiving at least one automated reminder if said second party fails to respond to said complaint within a first predetermined time interval after the receipt thereof.

17. The method for resolving disputes in accordance with claim 16, wherein, if said second party fails to respond online within a second predetermined time interval of said at least one automated reminder said case defaults to said merchant.

18. The method for resolving disputes in accordance with claim 12, the steps further comprising:
g) resolving said case at any time wherein either party thereto tenders an acceptable settlement offer.

19. The method for resolving disputes in accordance with claim 12, wherein said responding steps (b) and (c) are repeated until one of the group of events occurs: one party fails to respond within a period set therefore, and a settlement offer is accepted.

20. The method of creating a merchant seal online, the steps comprising:
a) visiting a first website;
b) selecting a form;
c) completing said form;
d) having said form reviewed and verified for accuracy; and
e) receiving a seal for display on a second website.
